(19) United States
(12) Patent Application Publication
(10) Pub. No.: US 2007/0110420 A1
(43) Pub. Date: May 17, 2007

(54) Image capture system having an adjustable focal length and related method

(76) Inventors: Ramin Samadani, Menlo Park, CA (US); D. Amnon Silverstein, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/280,741

(22) Filed: Nov. 16, 2005

(51) Int. Cl. G03B 17/00

(52) U.S. Cl. 396/72

(57) ABSTRACT

An image capture system and method for adjusting a focal length of a lens based on an amount of available light. The image capture system may include a lens assembly having a focal length, an image capture media capable of receiving light from the lens assembly, and a controller configured to adjust the focal length of the lens assembly and to access an amount of the image capture media to form an image of an object.

### FIELD OF THE INVENTION

The invention relates generally to photography. More particularly, the invention relates to image capture systems and methods for adjusting a focal length of a lens based on an amount of available light.

### BACKGROUND

Image capture systems (e.g., analog or digital cameras, camcorders, copiers, scanners, printers, etc.) generally include, among other things, a number of lenses or a lens assembly and a medium or device to capture and record an image. For analog image capture systems (e.g., analog cameras), the medium is film, which records the image through chemical processing, and for digital image capture systems (e.g., digital cameras), a sensor device and additional components are used to capture and record the image. For both types of image capture systems, the lens assembly is used to capture light from an object and focus the light on a desired area—e.g., the film or the sensor device.

In the case of digital image capture systems, the sensor device (e.g., a charge coupled or CMOS device) may include several sensor elements or picture elements (pixels) which convert the focused light into an electrical charge that represents an image. Each of the pixels is light sensitive, such that the brighter the light that hits a pixel, the greater the electrical charge that will accumulate at that site. Thus, in bright light, the pixels generate an electrical signal of greater magnitude compared to images captured in low-light conditions.

In recent years, the use of digital image capture systems has become increasingly popular because such systems allow instantaneous capture and recording of an image, relatively easy manipulation of the image, easy electronic display and transmission of the image, and printing of the image using a relatively inexpensive printer. In addition, the resolution of digital image capture systems continues to increase, making the systems more suitable for applications typically thought to require film imaging.

As the resolution of digital image capture systems continues to increase, various issues with recording and displaying a captured image arise. For example, as the resolution of an image capture system (governed by the number of pixels available for image capture) increases, the size of the pixels generally decreases, and as the size of each pixel decreases, the magnitude of an electrical signal generated from the pixel for a given amount of light from an object generally decreases. Thus, images formed with relatively small pixels include a proportionately increased amount of electrical noise, which in turn results in image noise. This noise becomes increasingly problematic as less light is available to capture the image because the noise becomes a greater portion of the electrical representation of the image.

One technique for compensating for the noise resulting from low-light conditions is to employ a lens configured to capture a greater amount of light. An amount of light captured by a lens is determined by its aperture and focal length. The amount of light captured by a lens can be increased by increasing an aperture size of the lens and/or by decreasing the focal length of the lens. However, as the size of a lens aperture increases, the size and cost of the lens generally increases, and as the focal length of the lens decreases, the magnification of the lens decreases. Moreover, light transmitted with a lens having a relatively large aperture and/or short focal length is brighter at the sensor around the optical axis compared to areas away from the axis. Lens assemblies designed to compensate for this effect are often prohibitively expensive. Thus, it is often not desirable to employ a lens with either a relatively large aperture and/or a relatively small focal length to compensate for the low-light conditions.

Another approach to compensate for low-light conditions includes post averaging the sensor electrical data. However, if the amount of light from an image is too low, this technique does not work well.

Accordingly, improved systems and methods for capturing and recording an image of an object in low-light conditions with relatively low noise are desired.

### SUMMARY OF THE INVENTION

The invention generally relates to image capture systems and methods for capturing and recording images of objects using a lens. While the ways in which the invention addresses the various drawbacks of the prior art will be discussed in greater detail below, in general, the invention provides systems and methods for reducing an amount of image noise associated with images captured in relatively low-light conditions.

In accordance with an embodiment of the invention, an image capture system may include a lens assembly having a focal length, an image capture media capable of receiving light from the lens assembly, and a controller configured to adjust the focal length of the lens assembly and to access an amount of the image capture media to form an image of an object.

In accordance with another embodiment of the invention, a method of operating an image capture device may include determining an amount of light proximate the image capture device, adjusting a focal length of the image capture device based on the amount of light and adjusting a resolution of an image based on the amount of light.

### BRIEF DESCRIPTION OF THE DRAWINGS

A more complete understanding of the invention may be derived by referring to the detailed description and claims, considered in connection with the figures, wherein like reference numbers refer to similar elements throughout the figures, and:

FIG. 1 is a schematic illustration of an image capture system in accordance with an exemplary embodiment of the invention;

FIG. 2 is an illustration of an image captured on a sensor device in bright-light conditions in accordance with an exemplary embodiment of the invention;

FIG. 3 is an illustration of an image captured on a sensor device in low-light conditions in accordance with an exemplary embodiment of the invention;

FIG. 4 is an illustration of a method in accordance with an exemplary embodiment of the invention; and

FIG. 5 is an illustration of a method in accordance with an exemplary embodiment of the invention.

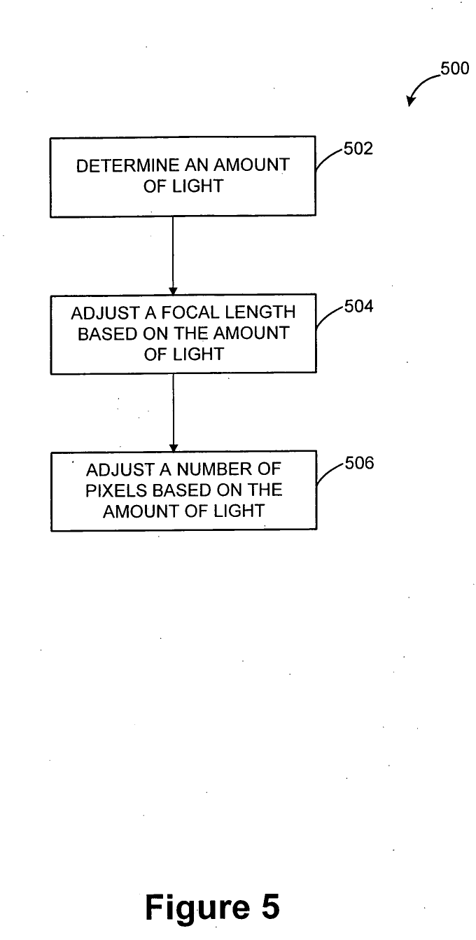

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the embodiments of the invention. Also, some of the elements in the figures are optional and may not be required for a particular embodiment of the invention.

### DETAILED DESCRIPTION

Although the invention may be used for film-based image capture systems and digital image capture systems, the invention is conveniently described below in connection with digital image capture systems. Furthermore, those skilled in the art will appreciate that the image capture systems may include components in addition to those described in detail below and that the embodiments described below are merely exemplary.

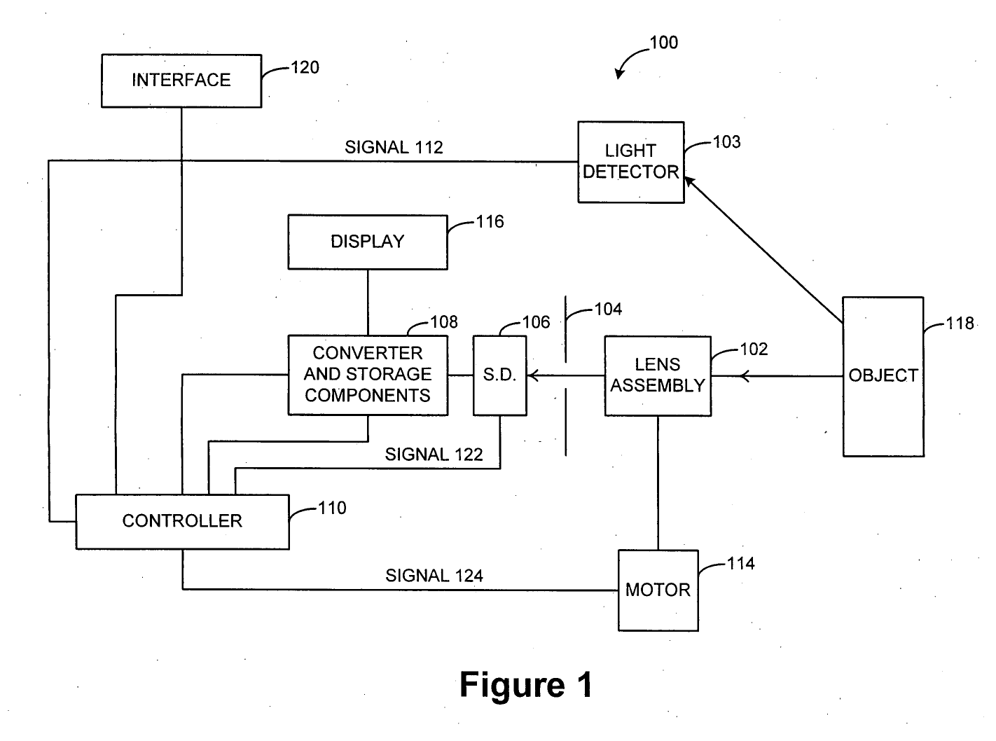

FIG. 1 illustrates an image capture system 100 in accordance with an exemplary embodiment of the invention. The image capture system 100 may include a lens assembly 102, a light detector 103, an aperture 104, a sensor device 106 (image capture media), converter and storage components 108, a controller 110, a lens assembly motor 114, a display 116, a user interface 120, and a housing, which, for convenience, is not illustrated. All of the components or elements shown in FIG. 1 and described herein are not required and may be optional depending on the particular embodiment. In operation, the image capture system 100 captures light from an object 118 and forms an electronic image of the object 118. More specifically, as explained in greater detail below, the image capture system 100 is configured to capture relatively high-resolution images of the object 118 in bright-light conditions and to capture relatively low-resolution, low-noise images of the object 118 in low-light conditions.

The lens assembly 102 is generally configured to have its focal length adjusted to allow images of various sizes to be formed on the sensor device 106. Lens assemblies suitable for use with the invention include, for example, zoom magnification lens assemblies which alter their focal length based on a zoom magnification. For such assemblies, the focal length is reduced as the lens assembly is used to zoom out on an image and the focal length is increased when the lens assembly is used to zoom in on an image. Suitable lens assemblies may be movably attached to the remaining portion of the image capture system 100 or may form an integral portion of the image capture system 100. Use of such a lens assembly in connection with the controller 110 and other system components described herein allows the image capture system 100 to alter modes where enough light is available to form a high resolution image on the sensor device 106 (large focal length mode) and a low resolution, low noise image on only a portion of the sensor device 106 in low-light conditions. In one embodiment, fewer pixels on the sensor device 106 receive light from the object 118, but each pixel receives a greater amount of light compared to conventional digital image capture systems, for which the image would be focused on all of the available pixels. Consequently, the image capture system 100 can be used to obtain low-noise (higher signal noise) images in low-light conditions without requiring expensive lens assemblies with large apertures or by post-averaging pixel information.

The light detector 103 may include a detector or a sensor (e.g., a diode) typically used in image capture system operations to detect an amount of ambient light (step 502). The light detector 103 may be integral with the remaining portions of the image capture system 100 or may be a separate device. In one embodiment, the light sensing function is performed by the sensor device 106. Hence, the light detector 103 may be optional. The light detector 103 may be positioned within or proximate to the lens assembly 102. In this embodiment, the image capture system 100 does not need a separate light detector such as the light detector 103. As discussed in more detail below, the light detector 103 detects an amount of available light for image formation and, in accordance with various embodiments of the invention, is capable of sending a signal 112 to the controller 110.

The sensor device 106 (also referred to as image capture media) includes several sensor elements capable of converting light into a voltage signal. Pixels are a logical grouping of sensor elements. For example, two green pixels, one red pixel and one blue pixel can make up a sensor element. By way of examples, the sensor device 106 may include a charge-coupled device (CCD) or complimentary metal oxide semiconductor (CMOS) device typically used in digital image capture systems such as digital cameras. The CCD is a light-sensitive integrated circuit that stores and displays the data for an image in such a way that each pixel in the image is converted into an electrical charge. In one embodiment, the sensor device 106 is a CCD which includes five or more megapixels. However, other devices, which may be of higher or lower resolution, are also considered to be within the scope of this invention. The sensor device 106 may be configured to sense an amount of available light proximate to the image capture system 100 (step 502). In one embodiment, the sensor device 106 sends a signal 122, indicative of an amount of available light, to the controller 110.

The converter and storage components 108 may be similar to converter and storage components found in typical digital image capture systems. Such components generally include analog-to-digital converters, to convert an analog signal representing the image from the sensor device 106 to a digital signal, and a memory and other components to store a digital copy of the image and enable display of the image on the display 116.

The controller 110 is configured to receive a signal 112, e.g., from the light detector 103, and to interact with and manipulate the lens assembly 102 and the sensor device 106. In one embodiment, the controller 110 is configured to receive a signal 112 indicative of an amount of light proximate to the light detector 103 and to provide a signal 124 to the lens assembly motor 114, which in turn causes the lens assembly 102 to alter its focal length (step 504) and also to send a signal 122 to the sensor device 106 to access or enable either all or a portion of the pixels on the sensor device 106 (step 506). In one embodiment, a user using an interface 120 may manually select a low-light mode of the image capture system 100 to be OFF, ON, or AUTOMATIC. In the OFF state, the controller 110 does not cause a manipulation in the focal length or the number of pixels available for image capture. In the ON or AUTOMATIC state, the controller 110 is configured to manipulate the focal length of the lens assembly 102 and a number of pixels available for image capture. The controller 110 may access only a portion of the available image capture media (e.g., film or pixels) in low-light conditions and may access a greater portion of the image capture media in bright-light conditions.

The controller 110 may be configured such that the focal length of the lens assembly 102 may be reduced to capture low-light images. In this embodiment, only a subset of the available pixels on the sensor device 106 are used to capture the image-enabling each pixel of the subset to receive a greater portion of the available light compared to systems that employ all available pixels in low-light conditions. Thus, issues of relatively high noise and low periphery image light are mitigated compared to conventional systems. The controller 110 is further configured such that the focal length of the lens assembly 102 can be increased to capture brighter images. In this embodiment, a greater portion of the pixels are used (e.g., accessed or enabled) to capture the image. Thus, higher resolution images may be obtained in conditions when more light is available to form an image, while lower resolution and lower noise images are captured in low-light conditions.

The controller 110 may include software (e.g., an algorithm), hardware, firmware, or combinations thereof to enable sensing and displaying of all the pixels or only a subset of the pixels located on the sensor device 106. In addition, the controller 110 may cause the lens assembly motor 114 to adjust the focal length of the lens assembly 102. Thus, for example, in low-light conditions, when the focal length of the lens assembly 102 is reduced and thus a desired image is formed on only a portion of the pixels of the sensor device 106, the controller 110 may communicate with the sensor device 106 and the converter and storage components 108 such that signals from only a portion of the available pixels on the sensor device 106 are accessed or enabled by the sensor device 106. Therefore, only information from a portion of the pixels is stored by the converter and storage components 108. Since only a portion of the pixels are accessed, enabled, read, displayed and/or stored, the image capture system 100 can operate faster in low-light conditions compared to conventional image capture systems. This allows better low-light burst-mode operation of the image capture system 100.

As discussed above, the mode of image capture system operation may be either manual or automatic. The image capture system 100 may be configured to allow a user to select between manual or automatic modes, or the image capture system 100 may include only a manual or an automatic mode. In the case where a user can select between manual and automatic modes, the user may select, for example, the mode to be OFF, ON, or AUTOMATIC. In the AUTOMATIC mode, the light detector 103 senses an amount of light proximate to the light detector 103 and the controller 110 determines an initial optimal exposure time or shutter speed to capture an image of the object 118. If the initial optimal exposure time is greater than a threshold time (e.g., 1/30th of a second), then the image capture system 100 switches from a normal mode of operation to a low-light mode of operation by reducing the focal length of the lens assembly 102, extracting only information from a subset of available pixels, and storing and/or displaying information from only the subset of pixels. The image capture system 100 then determines an exposure time based on the altered focal length of the lens assembly 102.

In the ON mode, the controller 110 causes the lens assembly motor 114 to adjust the lens assembly 102 to alter a focal length to a predetermined value, and the image capture system 100 operates as described above in connection with the description of the AUTOMATIC mode. In the OFF mode, the image capture system 100 operates similar to a traditional digital image capture system such as a traditional digital camera.

When the image capture system 100 is operating in the low-light mode, the controller 110 may be configured to set the focal length of the lens assembly 102 and the number of pixels available for image capture to a predetermined value (e.g. one-half of normal values). Alternatively, the controller 110 may be configured to scale (e.g., proportionately) the reduction of focal length and available pixels based on either an input from the light detector 103 or a user input.

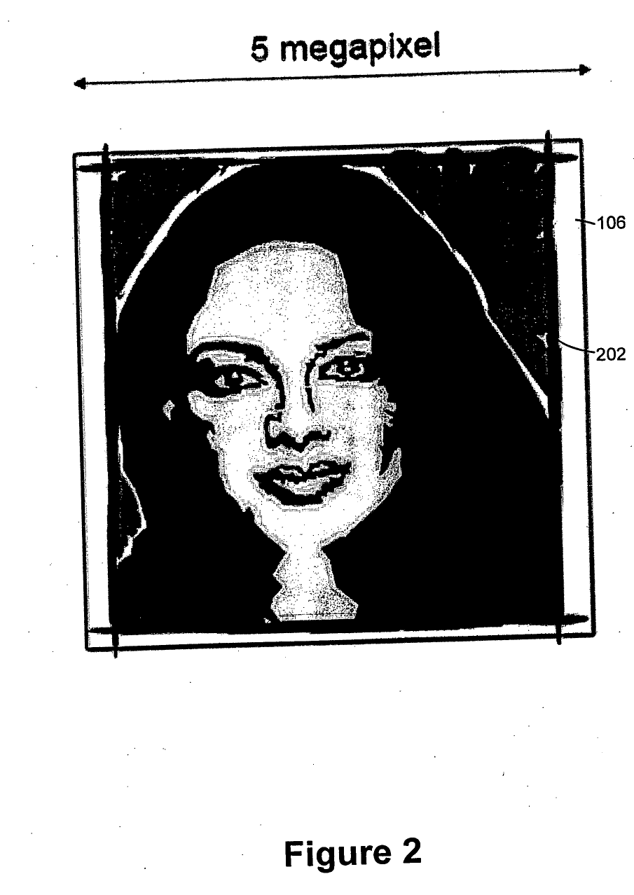

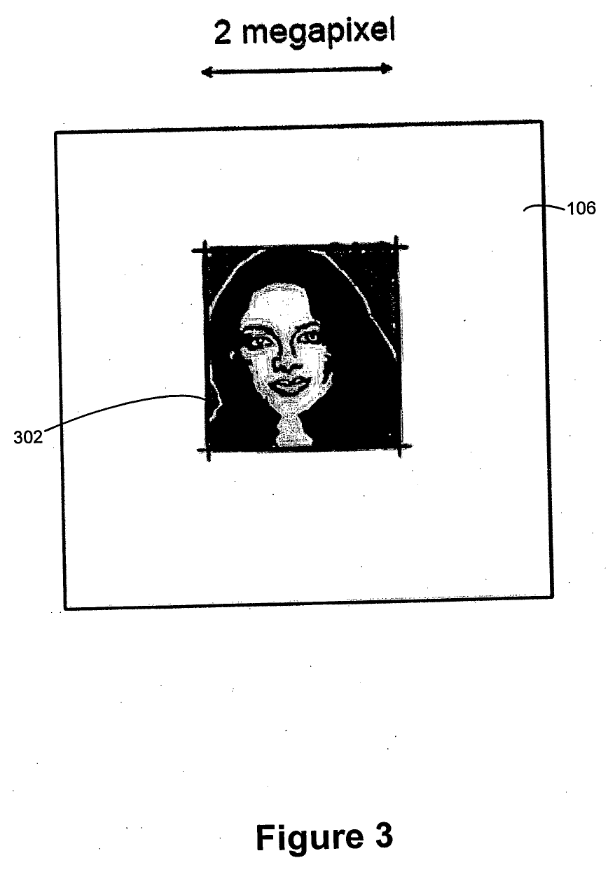

FIGS. 2 and 3 illustrate images captured in bright-light (high shutter speed) and low-light (low shutter speed) conditions, respectively, using the image capture system 100. As illustrated in FIG. 2, in bright-light conditions, an image 202 is focused on a relatively large portion of the sensor device 106, such that all or substantially all of the pixels available to convert light information into electrical signals are employed to capture the image. In contrast, FIG. 3 illustrates an image 302 captured in low-light conditions. In this case, the desired image is focused on only a fraction of the available pixels on the sensor device 106. Thus, the image of FIG. 3 is of lower resolution that the image of FIG. 2, because fewer pixels are used to capture the image. However, the image of FIG. 3 has less noise associated with the image, compared to images captured using conventional digital image capture systems, because each pixel used to capture the image receives a greater amount of light compared to images captured under the same condition using all of the available pixels.

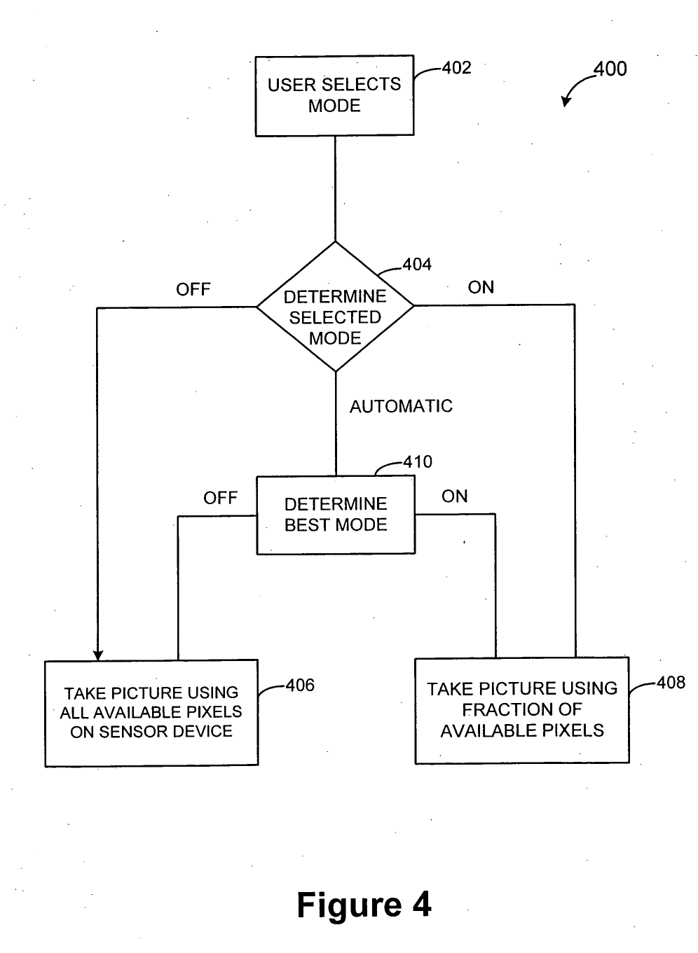

FIG. 4 illustrates a method 400 of photographing an image in accordance with an embodiment of the invention. In step 402, a user inputs or selects a “low-light operation” mode. In the illustrated example, the selectable modes include: OFF, ON, and AUTOMATIC, which may be selected using the user interface 120. At step 404, the image capture system 100 determines the user-selected mode. If a user selects the OFF mode, then method 400 proceeds to step 406 and the image capture system 100 is ready to take a picture in “normal” mode. If a user selects the ON mode, then method 400 proceeds to step 408 and the image capture system 100 is ready to take a picture in low-light conditions. If a user selects the AUTOMATIC mode, then method 400 proceeds to step 410 and the controller 110 determines the best mode for the conditions (e.g., conditions sensed by the light detector 103). In one embodiment, the mode may be determined by determining an initial optimal exposure time for the sensed conditions. If the exposure time is greater than a predetermined value (e.g., greater than about 1/30th of a second), then the method proceeds to step 408 and the image capture system 100 is ready to take a picture in low-light mode. If, on the other hand, the initial optimal exposure time is determined to be less than or equal to the threshold value, then the method proceeds from step 410 to step 406 and the image capture system 100 is ready to take a picture in “normal” mode.

The invention has been described above with reference to various exemplary embodiments. Those skilled in the art will recognize that changes and modifications may be made to the exemplary embodiments without departing from the scope of the invention. For example, the image capture system and method described herein may be used with film or other recording media. In addition, although not described above in detail, a variety of lenses and lens assemblies, which can alter a size of a focused image on a sensor device and/or the focal length of a lens assembly, can be used in connection with the invention. These alternatives can be suitably selected depending upon the particular application or in consideration of any number of factors associated with the operation of the system. These and other changes or modifications are intended to be included within the scope of the invention.

1. An image capture system comprising:
a lens assembly having a focal length;
an image capture media capable of receiving light from the lens assembly; and
a controller configured to adjust the focal length of the lens assembly and to access an amount of the image capture media to form an image of an object.

2. The image capture system according to claim 1, wherein the lens assembly is a zoom magnification lens and the focal length is adjusted by zooming in or out from the object.

3. The image capture system according to claim 1, wherein the image capture media is a charge coupled device.

4. The image capture system according to claim 1, wherein the image capture media is a complimentary metal oxide semiconductor device.

5. The image capture system according to claim 1, further comprises a motor coupled to the controller and the lens assembly, the motor configured to adjust the focal length of the lens assembly based on a signal received from the controller.

6. The image capture system according to claim 1, wherein the controller includes an algorithm to determine a portion of the image capture media to be used to form the image.

7. The image capture system according to claim 1, further comprising a light detector for sensing light, and wherein the controller is configured to determine an adjustment to the focal length of the lens assembly based on the light sensed by the light detector.

8. The image capture system according to claim 1, wherein the image capture media senses an amount of available light proximate the lens assembly.

9. The image capture system according to claim 1, wherein the controller includes user-selectable modes of ON, OFF, and AUTOMATIC.

10. The image capture system according to claim 1, wherein the controller includes an AUTOMATIC mode, determines an initial exposure time, and adjusts the focal length of the lens assembly if the initial exposure time is greater than a threshold value.

11. An image capture system for capturing lower resolution, lower noise images of an object in low-light conditions and higher resolution images of the object in bright-light conditions, the system comprising:
a lens assembly to receive light from the object;
a light detector to sense an amount of light adjacent to the lens assembly;
a sensor device to receive light from the lens assembly; and
a controller to determine an adjustment to a focal length of the lens assembly based on the amount of light sensed by the light detector.

12. The image capture system of claim 11, wherein the sensor device is a charge coupled device.

13. The image capture system of claim 11, wherein the sensor device is a complimentary metal oxide semiconductor device.

14. The image capture system of claim 11, further comprising a motor coupled to the controller and the lens assembly, the motor configured to manipulate the focal length of the lens assembly based on a signal received from the controller.

15. The image capture system of claim 11, wherein the controller is coupled to the sensor device and provides a signal to the sensor device to enable a portion of available pixels of the sensor device based on the amount of light sensed by the light detector.

16. The image capture system of claim 11, wherein the light detector forms a part of the sensor device.

17. An image capture system comprising:
means for providing a focal length;
means for receiving light from the means for providing the focal length; and
means for adjusting the focal length and accessing an amount of the means for receiving light to form an image of an object.

18. The image capture system according to claim 17, wherein the means for providing the focal length is a lens assembly.

19. The image capture system according to claim 17, wherein the means for receiving light is selected from a group consisting of a charge coupled device and a complimentary metal oxide semiconductor device.

20. A machine-readable medium that provides instructions, which when executed by a machine, cause the machine to perform operations comprising:
determining an amount of light proximate an image capture device;
adjusting a focal length of the image capture device based on the amount of light; and
adjusting a number of pixels for an image based on the amount of light.

21. The machine-readable medium according to claim 20, wherein the adjusting the focal length comprises decreasing the focal length in low-light conditions.

22. The machine-readable medium according to claim 20, wherein the adjusting the focal length comprises increasing the focal length in bright-light conditions.

23. The machine-readable medium according to claim 20, further comprising:
determining an initial exposure time based on the amount of light;
comparing the initial exposure time to a threshold value; and
adjusting the focal length of the image capture device only if the initial exposure time is greater than the threshold value.

24. A method of operating an image capture device, comprising:
determining an amount of light proximate the image capture device;
adjusting a focal length of the image capture device based on the amount of light; and
adjusting a number of pixels used for an image based on the amount of light.

25. The method of operating an image capture system according to claim 24, wherein the adjusting the focal length comprises decreasing the focal length in low-light conditions.

26. The method of operating an image capture system according to claim 24, wherein the adjusting the focal length comprises increasing the focal length in bright-light conditions.

27. The method of operating an image capture system according to claim 24, further comprising:
determining an initial exposure time based on the amount of light;
comparing the initial exposure time to a threshold value; and
adjusting the focal length of the image capture device only if the initial exposure time is greater than the threshold value.
